(19) United States
(12) Patent Application Publication
(10) Pub. No.: US 2004/0138991 A1
(43) Pub. Date: Jul. 15, 2004

(54) Anti-fraud document transaction system

(76) Inventors: Yuh-Shen Song, Northridge, CA (US); Catherine Lew, Northridge, CA (US); Alexander Song, Northridge, CA (US); Victoria Song, Northridge, CA (US)

Correspondence Address: FULBRIGHT AND JAWORSKI L L P, PATENT DOCKETING 29TH FLOOR, 865 SOUTH FIGUEROA STREET, LOS ANGELES, CA, 900172576

(21) Appl. No.: 10/646,314

(22) Filed: Aug. 21, 2003

Related U.S. Application Data
(60) Provisional application No. 60/438,574, filed on Jan. 9, 2003.
(60) Provisional application No. 60/463,535, filed on Apr. 18, 2003.
(60) Provisional application No. 60/488,985, filed on Jul. 22, 2003.
(60) Provisional application No. 60/488,987, filed on Jul. 22, 2003.
(60) Provisional application No. 60/488,988, filed on Jul. 22, 2003.

(51) Int. Cl. G06F 17/60

(52) U.S. Cl. 705/38

(57) ABSTRACT

Anti-fraud measures are implemented through networks for transactions using payment documents such as checks, letters of credit, notes, etc. as the payment instrument. The payer is authenticated and the availability of funds is verified by the payer's financial institution before the transaction is completed and the funds are immediately secured during the transaction. Since the transaction details are registered for verification purposes, neither payee nor third party has a chan e to alter any part of the transaction. The payment document may be an Anti-Fraud Check which has been endorsed with an anti-fraud system supplied “TIN” or “FSTIN” that provides better fraud protection than a conventional cashier's check or a traveler's check issued by a bank, and which can be issued without the usual required visit to a bank during bank office hours.

### CLAIM FOR PRIORITY

This application claims priority of U.S. provisional patent applications No. 60/438574 filed on Jan. 9, 2003, No. 60/463535 filed on Apr. 18, 2003, and Nos. 60/488985, 60/488987 and 60/488988 filed on Jul. 22, 2003, which are hereby incorporated in this application.

### CROSS REFERENCE TO RELATED APPLICATIONS

Certain embodiments of the present invention may find utility in combination with the teachings of our copending applications filed concurrently herewith and hereby incorporated by reference in their entirety:

Anti-Fraud POS Transaction System (attorney docket 7443-101)

Anti-Fraud Remote Cash Transaction System (attorney docket 7443-102)

### BACKGROUND OF THE INVENTION

The financial industry is losing billions of dollars every year as a result of fraud occurring through checks. These losses are growing every year as more and more con artists have learned how to defraud our financial system. Checks are the most frequently used form of payment in the U.S. financial system. According to the statistics reported by the Federal Reserve, more than 40 billion checks were issued in the year 2001, which contributed to about 60% of all payments in the U.S.

Due to the large volume of checks used in our daily life, most banks cannot afford to verify the signature on every check. Banks usually accept a check as long as the account information coded in the MICR format is a correct account and the dollar amount is not larger than a predetermined threshold, e.g., $3,000. As a result, even without stealing a check, a third party can easily fabricate a fake check by using commercially available check-printing software once the account information of a checking account is available.

For most cases, the signature and the physical appearance of the check are irrelevant as long as the dollar amount is not larger than the bank's predetermined threshold. A con artist can randomly pick any checking account number of a financial institution, print a check, fill in a dollar amount, sign a random name, and deposit it. Most likely, the con artist will get paid and the real checking account holder will not know what has happened until he/she receives the returned checks together with the monthly statement. An experienced con artist may fabricate fake checks against hundreds of checking accounts of a financial institution in a very short period of time, get paid, and disappear. There are more than twenty thousand financial institutions in the U.S.A. that provide checking accounts and are susceptible to this kind of fraud. Naturally, financial institutions are facing even higher risks as more people discover how easy it is to fool the financial system.

With today's advanced image editing technologies, a skillful con artist can easily duplicate a check or alter the payee name and dollar amount of a check. As a result, an expert may not be able to tell the difference when an altered check is presented to the financial institution, even if the dollar amount is larger than the predetermined threshold. There are quite a number of cases in which con artists have withdrawn hundreds of thousands of dollars from financial institutions in a single altered check without being detected.

Regulation CC further complicates the situation by requiring a financial institution to release the funds within a certain short period of time after a check is deposited. Very often, the funds have to be released even before knowing whether the drawee bank has accepted or rejected the returned check. In order to compete, some banks promote that they trust their customers and will release funds without any holding period for a deposited check. Thus, these banks have become a check-kiting haven. Consequently, financial institutions are losing billions of dollars every year as a result of check fraud.

Although some security measures, such as copy void pantograph, high-resolution micro-graphics, chemical coatings, watermarks, and reflective hollow strip, have been theoretically effective in deterring check fraud by payees or third parties, the problem still persists. The cost of implementing and verifying these additional security measures is so high that most banks and their customers just cannot afford to do it. Besides, these methods cannot prevent the payer from committing fraud.

It has been proposed that check issuers should imprint on the checks some sort of specially encrypted information, which can be used by the drawee bank to validate the payees and the dollar amounts, but this technology is not readily applicable to consumer transactions. In fact, there has not been a comprehensive, economical and practical solution to preventing check fraud.

The “Check 21” (i.e., “Checks for the 21^{st} Century”) proposal, which is expected to pass the U.S. Congress during the summer of 2003, will worsen the fraud situation. The “Check 21” proposal permits banks to approve or deny a check payment based on the image of the check. Although the “Check 21” proposal can speed up the check clearance process and save the transportation cost of paper checks, it opens other doors to fraud.

In order to compete in business, credit card companies often issue special “blank” checks, which their customers can use for any purposes. Once the customer uses the check, the used amount will be charged to the customer's credit card account. Consumers often use these checks to transfer debt balance from one high-interest account, such as a car loan account, to the credit card account, which often offers special terms to attract these “balance transfer” transactions. This is a smart way for the credit card companies to earn additional business from their customers. However, if these checks fall into the hands of con artists, they can easily use these checks and escape without any obligation. Since credit card companies may receive tens of thousands of returned “balance transfer” checks during one day, there is no easy way for the credit companies to detect and prevent this kind of “identity theft,” which has become a major concern to the credit card companies and the consumers.

### SUMMARY OF THE INVENTION

The present invention relates generally to financial transactions. More specifically, the present invention provides anti-fraud measures implemented through networks for transactions using payment documents such as checks, letters of credit, notes, etc. as the payment instrument.

In this document, the terminology “network” or “networks” generally refers to a communication network or networks, which can be wireless or wired, private or public, or a combination of them, and includes the well-known Internet. Similarly, “bank” or “financial institution” generally refers to a financial service provider, either a bank or a non-bank, where financial services are provided; and bank account” or “financial account” generally refers to an account in a financial institution, either a bank or a non-bank, where financial transactions are conducted through payment instruments such as checks, credit cards, debit cards, electronic fund transfers, etc.

One objective of the present invention is to reduce document payment fraud committed by payees (e.g., merchants), payers (i.e., account holders) and/or third parties (i.e., con artists), thereby reducing resultant financial losses to merchants, financial institutions (e.g., banks, etc.), business organizations, and/or consumers (e.g., account holders).

Another more specific objective is to prevent (or at least reduce) check kiting, check fraud, and insufficient funds, which are major concerns to financial institutions today.

According to one aspect of the present invention, the payer is authenticated and the availability of funds is verified by the payer's financial institution before the transaction is completed and the funds are immediately secured during the transaction so that the payer cannot deny the transaction later or otherwise commit payer fraud on the payee.

In accordance with another aspect of the present invention, a payee is prevented from entering into or modifying any transaction without obtaining express consent from a specified payer for a specific transaction amount that has been authenticated and verified by the payer's financial institution, so that the merchant cannot submit a fake or altered transaction or otherwise commit payee fraud.

In accordance with yet another aspect of the present invention, both the payee and the payer are authenticated and the details of the entire transaction are securely verified and maintained in such a way that no third party has a chance to alter any part of the transaction, thereby preventing third party fraud.

In one embodiment of the present invention, the payment document is an Anti-Fraud Check which has been endorsed with an anti-fraud system supplied “TIN” or “FSTIN” which provides better fraud protection than a conventional cashier's check or a traveler's check issued by a bank, and which can be issued without the usual required visit to a bank during bank office hours. Instead, the payer can issue an Anti-Fraud Check at any time, anywhere in the world. In other alternative embodiments of the present invention, similar “TIN” and “FSTIN” based provisions extend anti-fraud protection to general-purpose payment documents such as letters of credit, notes, etc.

### BRIEF DESCRIPTION OF THE FIGURES

FIG. 1 represents certain exemplary embodiments for anti-fraud systems for payments to remote payees from a payer's bank account, a credit card account or a debit card account, using a check or other negotiable document.

FIG. 2 (comprising FIG. 2A, FIG. 2B and FIG. 2C) is a flow chart for an exemplary process that may be used in the systems of FIG. 1.

### DETAILED DESCRIPTION OF CERTAIN PREFERRED EMBODIMENTS AND COMBINATIONS OF EMBODIMENTS

The present invention is part of a comprehensive suite of anti-fraud payment systems, which are applicable not only to such traditional payment instruments such as checks, credit cards and debit cards, but also to other transaction methodologies that have been or will be developed to support electronic commerce between parties that do not have established credit with one another, and potentially includes a number of embodiments to provide maximum flexibility so that these payment systems can satisfy many different needs, of both sophisticated and unsophisticated users. Accordingly, we will describe in detail only a few examples of certain preferred embodiments and combinations of the embodiments of the present invention; other inventive anti-fraud payment systems are disclosed in or will otherwise be apparent from the above-referenced copending applications.

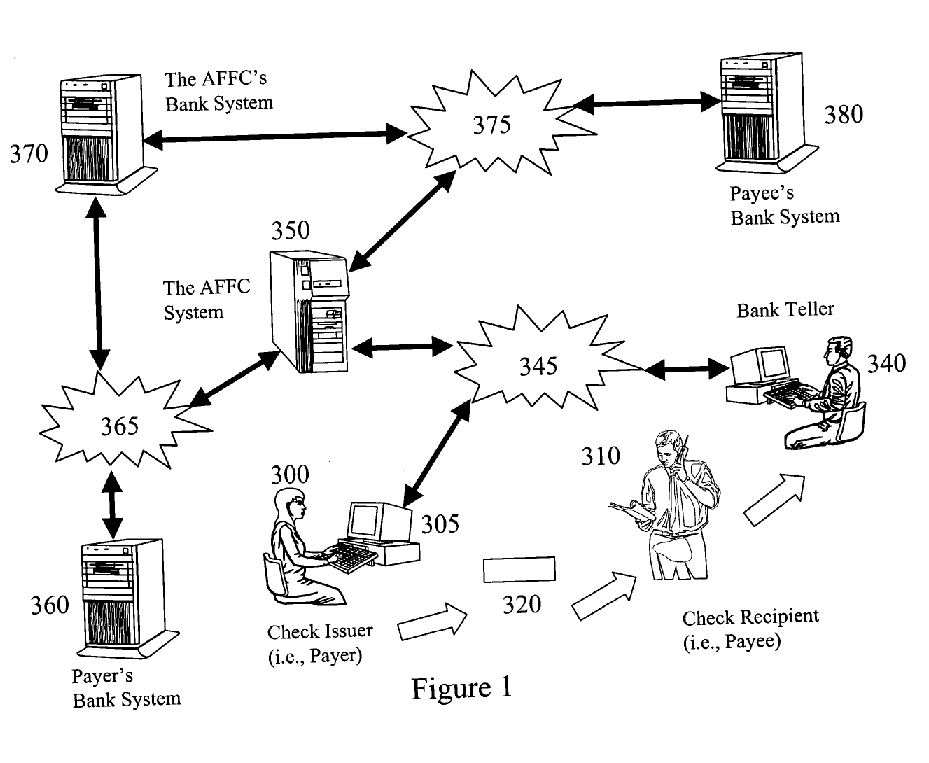

FIG. 1 illustrates certain preferred embodiments of a system for conducting check payment transactions, using an Anti-Fraud Financial Center (“AFFC”) 350. An anti-fraud payment through documents such as checks is accomplished by conducting the transactions through the Anti-Fraud Financial Center (“AFFC”). Although as currently contemplated the AFFC 350 is independent of the other financial institutions, it could be established exclusively by or for one specific financial institution to provide services to the customers of that financial institution. The payer can open an account with the AFFC only after authentication of the payer's identity. The authentication can be conducted indirectly through the payer's financial institutions or directly through the AFFC system. Similarly, the payee's identity must be authenticated by the AFFC before any funds can be transferred to the payee's financial institution.

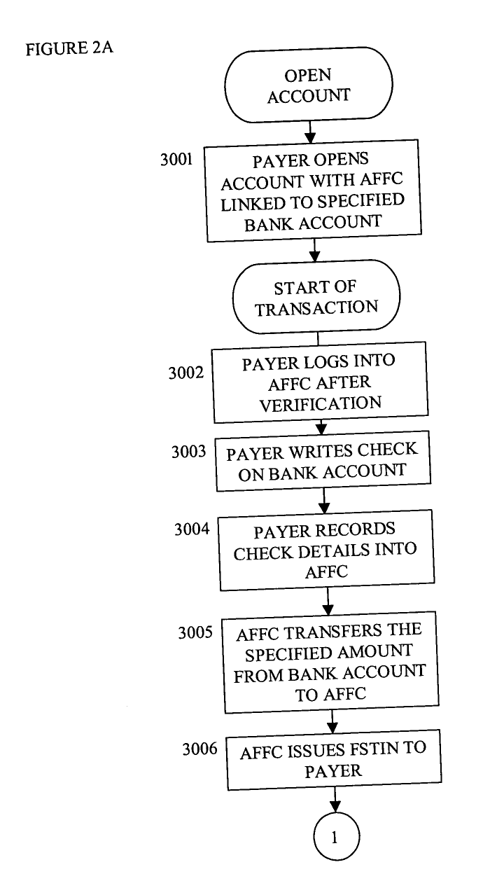

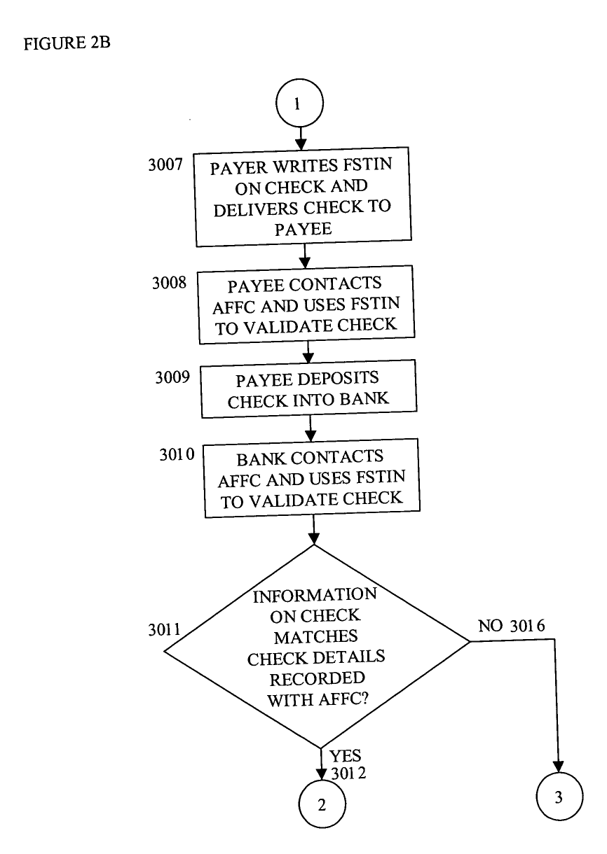

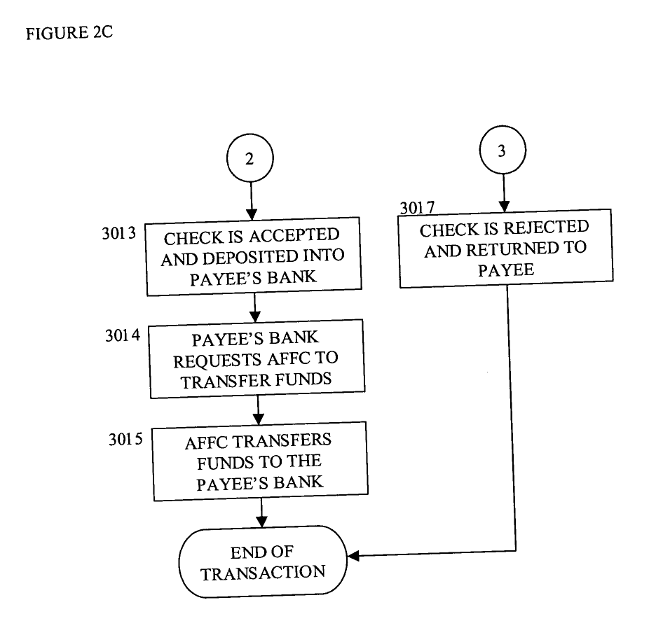

Reference should now be made to the flowchart of FIG. 2 in combination with the system diagram of FIG. 1, which together illustrate the operation of various embodiments of the system aspects of the present invention.

As indicated in block 3001, payer 300 has to open an account with the Anti-Fraud Financial Center (“AFFC”) 350 through a secure network 345 before being able to issue an anti-fraud check 320. A verification process is required to authenticate the payer's identity before the payer can open any account with the Anti-Fraud Financial Center.

In one embodiment of the present invention, the payer 300 opens the AFFC account through his/her existing financial institution 360, either in person or over secure networks 345, 365. A user password or other user identification information (such as user ID, driver's license number, social security number, name, address, data of birth, phone number, biometric information, etc.) must be verified by the payer's financial institution and stored into the customer database of the AFFC system. In addition, financial account numbers of the account holder must be authenticated and stored in the customer database of the AFFC system. In another embodiment of the present invention, the payer uses a personal computer 305 to open the AFFC account directly in the AFFC system 350 over secure network 345. The payer has to enter into the AFFC system payer's identification information such as user ID, password, driver's license number, social security number, name, address, date of birth, phone number, biometric information, etc. In addition, financial account numbers of the account holder must be entered and stored in the customer database of the AFFC system 350. Then, the AFFC system can verify the accuracy of the information provided by the payer 300 through the traditional verification process before opening an account for the payer. Alternatively, the AFFC system 350 may provide the payer 300 with a small identification device (not shown), which can read the machine-readable, embedded coded data of an official identification card such as a driver's license or a military ID card. The payer connects the identification device to his/her computer 305 and logs into the AFFC system 350 via network 345 to open an account. This identification device reads the embedded coded identification information from payer's machine-readable official identification card and sends the information to the AFFC. In other embodiments, a radio frequency identification (“RFID”) device or other wireless data transmission device may be incorporated into the identification card; and the identification information is read from the identification card through an RFID reader or other wireless data receiver.

The AFFC system 350 verifies payer's identification information with the account holder information of the financial accounts identified by the payer. If the verification is successful, the payer's AFFC account is opened; the payer enters into the AFFC system payer's other information such as user ID, password, driver's license number, social security number, name, address, date of birth, phone number, biometric information, etc.; and the payer is ready to conduct anti-fraud document payment transactions. In another alternative embodiment of the present invention, the payer opens the AFFC account directly through a remote AFFC service depot (not shown), which preferably has incorporated the above-described identification device, and which preferably is installed in a regular office and is supervised by personnel appointed by the networked financial center. The AFFC account is opened after verifying the payer's identity through an official identification card with the account holder information of the financial accounts identified by the payer. The payer has to enter into the AFFC system payer's other information such as user ID, password, driver's license number, social security number, name, address, date of birth, phone number, biometric information, etc. After the AFFC account is opened, the payer can conduct an anti-fraud payment transaction using a document such as a check.

When a payer intends to issue a general-purpose, anti-fraud document payment, the payer logs into the Anti-Fraud Financial Center (“AFFC”) (block 3002), writes a check (block 3003), records the payee information, dollar amount, document identification number, and other related information into the database of the AFFC system 350 through a network 345 (block 3004),

In one embodiment of the present invention, the payer logs into the AFFC system to issue an anti-fraud payment through the standard approach using User ID and password. In other embodiments, the payer has to use the previously mentioned identification device each time he or she logs into the AFFC system. The identification device reads the embedded coded identification information from payer's official identification card and sends the information to the AFFC system for verification. The login will not be approved without an official identification card containing payer's information that matches the account holder information of the AFFC account as specified by the payer. If a business account is involved, the official identification card of the signer can be used.

In other embodiments, the identification device reads a piece of biometric information such as a fingerprint, which will be verified with the information stored in the customer database of the AFFC system. Driver's license numbers and social security numbers are standard information stored inside the customer database of financial institutions today, while biometric information is not stored yet. Due to privacy concerns and the high cost involved in the identification process, storing biometric information into the customer database of the financial institution may not be easily implemented. It may take some time to establish a biometric information database in the AFFC system. Alternatively, the biometric information may be stored inside the identification card. Once the account holder information obtained from the AFFC system matches the information obtained from the identification card, the identification card is proven to be a valid one. Then, the biometric information stored inside the identification card can be used to authenticate the identity of the payer.

In a preferred embodiment of the present invention, once the check details have been recorded (block 3004), the AFFC system 350 immediately transfers the transaction amount from the payer's bank system 360 to the AFFC's bank system 370 through ATM network (or other competing real-time network) 365 (block 3005).

Next (block 3006), the AFFC system 350 assigns a Funds Secured Transaction Identification Number (“FSTIN”) for the payer to write on the document. This provision to immediately transfer funds out from the payer's account makes sure that the payer cannot commit any fraud. However, in other embodiments, particularly when payer fraud is not a concern, the AFFC system 350 may omit so securing the funds but instead merely assigns a simple Transaction Identification Number (“TIN”).

As indicated in block 3007, the payer writes the FSTIN (or TIN) on the check 320 and delivers the check to the payee 310.

Upon receipt of the check 320 endorsed with the required FSTIN (or TIN), the payee 310 has the ability to log into the AFFC system 350 through a network 345 to verify the validity of the check 320 based on the FSTIN (block 3008) . For privacy protection, the payee may be requested to input the dollar amount or check number for verification purposes in addition to the FSTIN or TIN. Since the validity of the check has been thus verified and the indicated funds have already been secured, the payee is protected from payer fraud even if the check is not immediately submitted to a financial institution for collection.

Next (block 3009) payee 310 deposits the check 320 with the bank teller 340. The bank teller 340 logs into the AFFC system 350 through a network 345 to verify the validity of the check 320 based on the FSTIN (block 3010). The AFFC then confirms (decision block 3011) whether the payee and amount on the check agree with the payee name and amount previously entered by the payer 300. The bank teller authenticates the identity of the payee 310 either by conventional means, or preferably by using the above described identification device and/or by using personal and/or biometric information supplied by the payee. After the amount and payee identity have been verified and the transaction matches the information associated with the TIN/FSTIN (YES branch 3012), the teller 340 accepts the check 320 for deposit (block 3013) and the AFFC system 350 immediately transfers the transaction funds (block 3015) to the payee's financial institution 380 from the AFFC Bank System 370 (FSTIN) or directly from the payer's bank system 360 (TIN) over the secure networks 375 and 365. If FSTIN is used, the funds are in the AFFC bank and payer fraud is not a concern. Funds can be transferred from the AFFC bank system to the payee's financial account through ACH, ATM or other real-time or non-real-time networks. However, if TIN is used, the funds are still in payer's financial account and, to avoid check kiting, insufficient funds, etc., the funds must be secured in real time when the check 320 is presented, by immediately transferring the funds from the payer's financial account (by means of an ATM or other competing real-time network) to the payee's financial account. In either event, once the AFFC system confirms that the funds are secured, the payee's financial institution can freely release the funds to the payee without worrying about insufficient funds, check kiting, or check fraud.

If the information obtained from the AFFC system 350 based on the FSTIN does not match the information on the check 320 (NO branch 3016), the check is rejected (block 3017) right away.

There is no chance for the payee or any third party to alter the check because the FSTIN or TIN provision validates the transaction. A clear message of “paid” will be “marked” on the document by the payee's financial institution to prevent it from being circulated in the traditional financial system. It is recommended that the payee's financial institution keep the “marked payment document” or its image as evidence in case of any dispute. If a payment document with the TIN provision is deposited into a financial institution that does not use the present invention to process this document, the payment document can still be processed through the traditional financial system without any conflict. However, under such circumstances, the payee financial institution will lose the great protection offered by the present invention. If the TIN is used, the payer can still cheat the payee by leaving insufficient funds in the account without being detected until the payee's financial institution starts the verification process. To prevent this kind of fraud from happening, an FSTIN approach is preferably used.

Several possible levels of security can be applied during authentication of an account holder during a login process by using different embodiments of the present invention. A mixed version of security levels is possible for practical business purposes. For example, different levels of security can be required based on the dollar amount involved in the transaction. Since the payee cannot initiate any transaction, all of the above embodiments and a mixed version of them can ensure that the payee cannot fabricate fake transactions based on the knowledge about the payer. Since third parties are excluded from the transactions, there is no chance for a third party to commit fraud. During business practice, a trade-off among different security requirements may be chosen in order to provide the most cost-effective and user-friendly solution. Such a trade-off should not be construed as a deviation from the present invention.

Those skilled in the art will realize that the secure networks 345, 365 and 375 can in practice be different secure paths over a common public network such as the Internet. Those skilled in the art will also realize it is possible to directly integrate AFFC system 350 into existing ATM, credit card, or debit card networks.

Due to the similarity between the AFFC system of the present invention and other systems described in the related inventions linked to the same provisional patent applications as described above, it is practical for business reasons to establish one system that integrates all these systems of the related inventions. As a result, the integrated system becomes a universal anti-fraud payment system that can be used for all types of transactions.

The embodiments described in this document can be assembled to form a variety of applications based on the need. Workers skilled in the art and technology to which this invention pertains will appreciate that alterations and changes in the described structure may be practiced without meaningfully departing from the principal, spirit and scope of this invention.

In one exemplary such modification of present invention, a payer's credit card company may open an AFFC account for the payer and request the payer to register the “balance transfer checks” in the AFFC system in order to prevent identify theft.

In other modified embodiments of the present invention, an agent (not shown) can be jointly appointed by the payer and the payee to perform an equivalent escrow function based on the terms and conditions agreed upon between the payer and the payee. The procedure to issue payment and to receive payment is the same as the embodiments described in this document. However, the payment will not be released to the payee unless the appointed agent has authorized the action. Through this approach, both the payer's and the payee's interests are fully protected, and trading fraud is eliminated.

1. A computerized method for verification and processing of a financial transaction using a documentary payment instrument to effect a transfer of funds from a payer's financial institution account to a payee's financial institution account, comprising:
opening an account for a payer in a networked financial center after authenticating the payer's identity, payer's financial institution and the specific account at that institution;
again authenticating the payer's identity before the payer can register a payment instrument with the networked financial center;
guiding the payer though a payment instrument registration process in which the payee's name, identification information, and transaction amount is entered into a database of the networked financial center;
issuing a unique Transaction Identification Number for the registered payment instrument;
authenticating the payee's identity before the payee can perform any transaction with the networked financial center;
once the payee's identity has been authenticated, using the Transaction Identification Number to access the database of the networked financial center in order to verify that the payee's identity and the transaction amount on the payment instrument match the payee information and the transaction amount registered by the payer into the database of networked financial center; and
if the verification is successful and the specified transaction funds are available, causing the funds to be transferred to the payee's financial institution account.

2. The method of claim 1 further comprising:
using a machine-readable official identification card to open the payer's account with the networked financial center, wherein the account is opened only if the embedded identification information read from the payer's identification card matches the account holder information of the financial account identified by the payer.

3. The method of claim 2 further comprising:
prompting the payer to input an additional item of personal information not embedded in the identification card but stored in the remote database of the financial institution; and
verifying that the additional personal information input by the payer matches the personal information stored in the remote database.

4. The method of claim 3, wherein the personal information input by the payer includes at least part of a social security number.

5. The method of claim 3, wherein the personal information input by the payer includes at least biometric information.

6. The method of claim 5, wherein the biometric information input by the payer includes at least a fingerprint.

7. The method of claim 2 further comprising:
prompting the payer to input an additional item of personal information embedded in the identification card but not stored in the remote database of the financial institution; and
verifying that the additional personal information input by the payer matches the personal information embedded in the identification card.

8. The method of claim 7, wherein the additional personal information input by the payer includes at least a personal identification number.

9. The method of claim 7, wherein the additional personal information input by the payer includes at least biometric information.

10. The method of claim 9, wherein the biometric information input by the payer includes at least a fingerprint.

11. The method of claim 1 further comprising:
using a machine-readable official identification card to register payment instrument information with the networked financial center, wherein the information is registered only if the embedded identification information read from the payer's identification card matches the account holder information of the financial account identified by the payer.

12. The method of claim 11 further comprising:
prompting the payer to input an additional item of personal information not embedded in the identification card but stored in the database; and
verifying that the additional personal information input by the payer matches the personal information stored in the database.

13. The method of claim 12, wherein the personal information input by the payer includes at least part of a social security number.

14. The method of claim 12, wherein the additional personal information input by the payer includes at least biometric information.

15. The method of claim 14, wherein the biometric information input by the payer includes at least a fingerprint.

16. The method of claim 11 further comprising:
prompting the payer to input an additional item of personal information embedded in the identification card but not stored in the database; and
verifying that the additional personal information input by the payer matches the personal information embedded in the identification card.

17. The method of claim 16, wherein the additional personal information input by the payer includes at least a personal identification number.

18. The method of claim 16, wherein the additional personal information input by the payer includes at least biometric information.

19. The method of claim 18, wherein the biometric information input by the payer includes at least a fingerprint.

20. The method of claim 1 further comprising:
permitting the payee to request payment directly from a networked remote service depot terminal equipped with a device for reading the payee's machine-readable official identification card;
verifying that the payee's identification information read from the official identification card matches the payee information entered by the payer into the database; and
if the verification of the payee's identity is successful and the transaction funds are available, issuing the payment directly to the payee from the networked remote service depot terminal.

21. The method of claim 20 further comprising:
requesting the payee to input an additional item of personal information not embedded in the identification card but stored in the database; and
verifying that the additional personal information input by the payee matches the personal information stored in the database.

22. The method of claim 21, wherein the personal information input by the payee includes at least part of a password.

23. The method of claim 21, wherein the additional personal information input by the payee includes at least biometric information.

24. The method of claim 23, wherein the biometric information input by the payee includes at least a fingerprint.

25. The method of claim 20 further comprising:
prompting the payee to input an additional item of personal information embedded in the identification card but not stored in the database, and
verifying that the additional personal information input by the payee matches the personal information embedded in the identification card.

26. The method of claim 25, wherein the additional personal information input by the payee includes at least a personal identification number.

27. The method of claim 25, wherein the additional personal information input by the payee includes at least biometric information.

28. The method of claim 27, wherein the biometric information input by the payee includes at least a fingerprint.

29. The method of claim 1 further comprising:
including an escrow agent into the transaction based on the agreement between payer and payee whereby the payee cannot receive payment unless the escrow agent has approved the payment first.

30. The method of claim 1, wherein the payment documents include paper checks.

31. The method of claim 1, wherein the payment documents include letters of credit.

32. The method of claim 1, wherein the payment documents include notes.

33. The method of claim 1, wherein the payment documents include other payment-oriented financial documents.

34. The method of claim 20, wherein the remote depot terminal is installed in a regular office under the supervision of personnel appointed by the networked financial center.

35. The method of claim 1, wherein the transaction funds associated with the unique Transaction Identification Number are electronically transferred from the specified payer's account at the specified payer's financial institution to an account maintained by the networked financial center prior to divulging that unique Transaction Identification Number to either the payer or the payee.

36. The method of claim 1, wherein the unique Transaction Identification Number is marked on the payment document in a machine-readable format.

37. The method of claim 36, wherein the machine-readable format is optically scanable.

38. The method of claim 1 further comprising:
permitting the payer's financial institution to open an account in the networked financial center on behalf of the payer.

39. The method of claim 38, wherein the payer's account in the networked financial center opened by the payer's financial institution is linked to a specific payer's account of that financial institution.

40. The method of claim 1, wherein:
the networked financial center is established exclusively for one financial institution to provide services to the customers of the financial institution.

41. The method of claim 2, wherein:
a wireless data transmission device is incorporated into the identification card; and
a wireless data receiver reads the machine-readable identification information of the identification card.

42. The method of claim 11, wherein
a wireless data transmission device is incorporated into the identification card; and
a wireless data receiver reads the machine-readable identification information of the identification card.

43. The method of claim 20, wherein
a wireless data transmission device is incorporated into the identification card; and
a wireless data receiver reads the machine-readable identification information of the identification card.
